(19) United States
(12) Patent Application Publication
(10) Pub. No.: US 2007/0107805 A1
(43) Pub. Date: May 17, 2007

(54) Compact and portable wood splitter

(76) Inventor: Martin Lessard, Lamarche (CA)

Correspondence Address: C/o Paul Biron, P.O. Box 0732, Jackman, ME, 04945-0732, US

(21) Appl. No.: 11/601,647

(22) Filed: Nov. 20, 2006

(30) Foreign Application Priority Data
Nov. 14, 2005 (CA) 2,525,495

(51) Int. Cl. B27L 7/00

(52) U.S. Cl. 144/193.2; 144/195.8

(57) ABSTRACT

The present invention concerns a compact, portable, lightweight, easily transportable, quickly operating wood splitting apparatus, using a knife which cuts a log or piece of wood that is deposed on a platform. This compact and portable wood splitter is actuated by a hydraulic cylinder transmitting a pendulum movement to a knife and onto an upright piece of wood. The apparatus may be attached to a truck box, to a trailer or to a wall by means of a vertical, horizontal, fixed or mobile fixture. The splitter apparatus is compact and portable and it can easily be stored in a car trunk or in a shed.

### BACKGROUND OF THE INVENTION

This invention relates to the field of wood splitting using an apparatus which can be carried easily from one place to another.

### PRIOR ART

Our research among patents revealed some systems that caught our attention:

U.S. Pat No. 4,275,779, U.S. Pat. No. 5,526,855, U.S. Pat. No. 4,537,235, U.S. Pat. No. 4,700,759, U.S. Pat. No. 4,782,870, CA 1,084,814 These inventions describe methods of wood splitting using a cutting wedge for splitting wood logs.

U.S. Pat. No. 4,782,870, CA 1,084,814 and U.S. Pat. No. 5,526,855, U.S. Pat. No. 5,337,810. These bulky and heavy wood splitters have to be mounted on trailers moved by a car, a truck or a tractor.

U.S. Pat. No. 4,751,949 utilises a straight blade knife.

### OBJECTIVES AND ADVANTAGES

A general objective of this invention is the providing of an apparatus for splitting wood logs, particularly providing a portable wood splitter which can be easily carried and lifted up.

A specific objective of the invention is to provide an apparatus which can carry out wood splitting quickly. More specifically that the apparatus be light in weight and easily handled; it be easily stored due to its small volume (ex. It can be stored and carried in a car trunk). The splitting process is to be carried out by a pendulum positioned knife moved by an upwardly moving cylinder.

The apparatus can adapt to variable log sizes.

### BRIEF DESCRIPTION OF DRAWING FIGURES

FIG. 1 is a perspective view of the wood splitter.

FIG. 2 is a side view of the knife.

FIG. 3 is a side view of the pivot.

FIG. 4 is a side view of the wood splitter.

FIG. 5 is a side view of the internal elements of the wood splitter: knife with the expanded cylinder.

FIG. 6 is a side view of the internal elements of the wood splitter: knife with the contracted cylinder.

### DETAILED DESCRIPTION OF THE PREFERRED EMBODIMENTS

In the following description and in the accompanying drawings, the numeral numbers refers to identical parts in the various Figures.

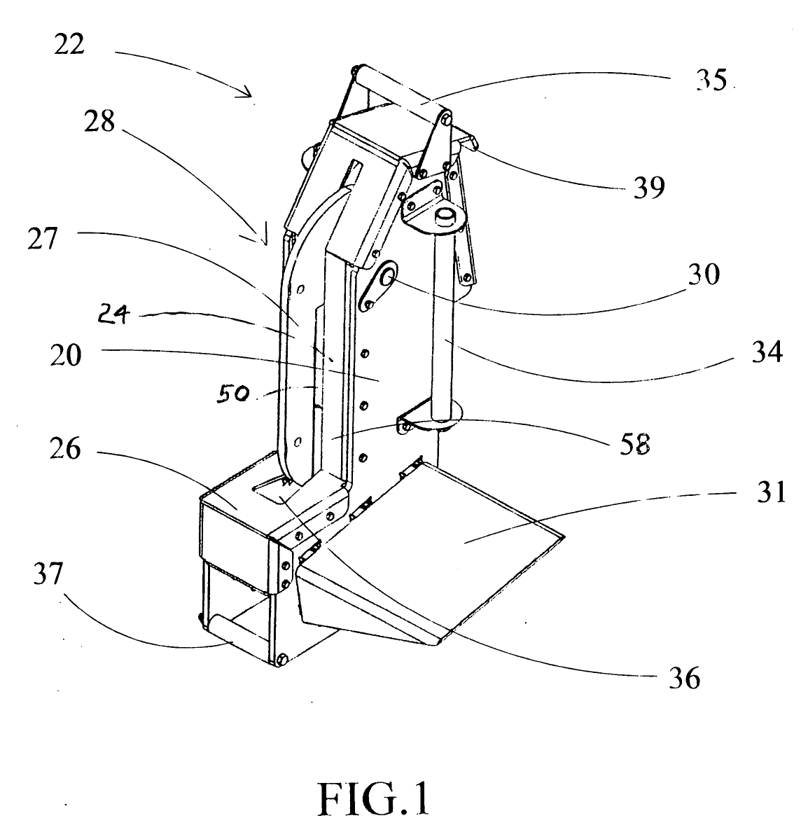

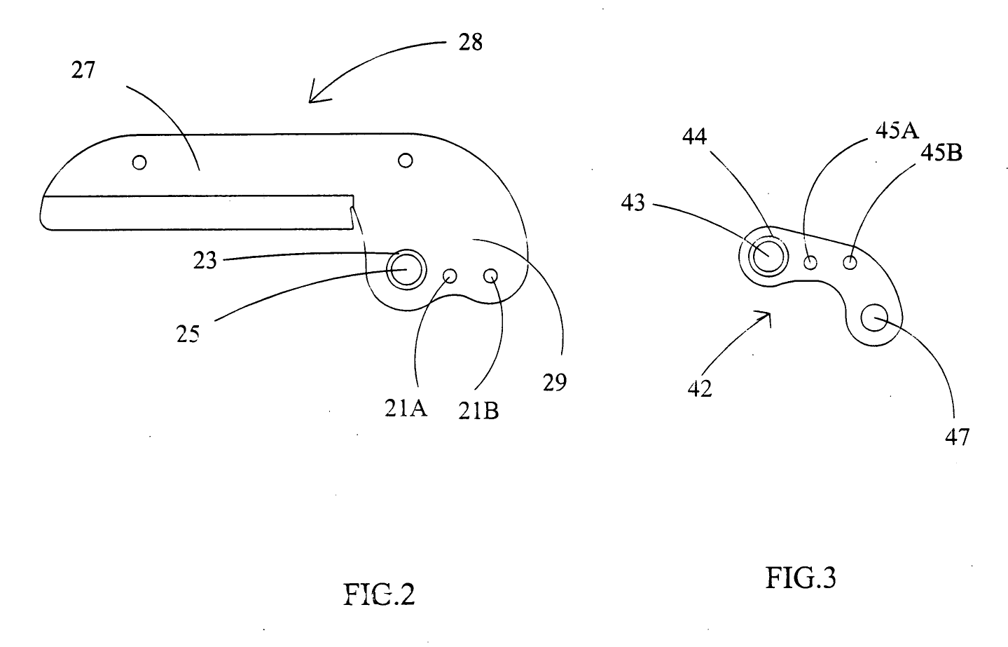

FIG. 1 shows the wood splitter 22, which possesses a protective enclosure 20. The protective enclosure 20 is supplied with lateral 34, top 35 and bottom 37 handles for helping in handling of the wood splitter 22. At the top of the wood splitter enclosure 20, a dorsal hook 39 is used for installation of the apparatus on a wall at a user's convenience. At the base of the enclosure, a lateral shelf 31 is positioned on one or the other side of the enclosure: it can easily be installed or de-installed. There is a front platform 26 for holding a piece of log. The platform is provided with a rectangular hole 36 for allowing wood debris to pass through during and after a log cut. The enclosure is provided with a rigid front part 24 which is vertically sustaining a pivot attachment pin 30. The main element of the apparatus is a knife 28, of which a blade 27 located as an external part with respect to the enclosure 20 and more particularly to the pivot pin 30, which acts as a rotation pivot for the knife 28. The knife 28 is inserted in a slit 50 located in the front face rigid part 24 of the enclosure 20. The slit 50 comprises an internal supporting plate 58 against which the blade 27 of the knife 28 is to rest after the cutting process is done so that the wood splitting be done safely. FIG. 2 shows the knife 28 comprising an external part, the blade 27, and an internal part, an arched extension 29 which possesses an attachment hole 23 allowing the knife 28 to rotate around a rotation pivot 25. Two small holes 21A and 21B in the lower area of the arched extension are used for attachment to a lever.

FIG. 3 shows the lever part 42 used for linking the knife 28 to a cylinder in such a way that the force be efficiently applied from the cylinder to the knife. On the lever part 42, there are four holes. the pivot hole 43 having the largest diameter corresponds to the pivoting axis of the pivot pin 30. The smaller diameter holes 45A and 45B are linked to attachment points of the knife holes 21A and 21B using bolts. A bearing bushing 44 is placed at the edge of the pivot hole 43. A cylinder attachment hole 47 Is used for attachment of the lever to a cylinder. The lever part is linked to the cylinder using a pivot pin inserted in the hole, so that a rotation movement around the hole 47 is performed.

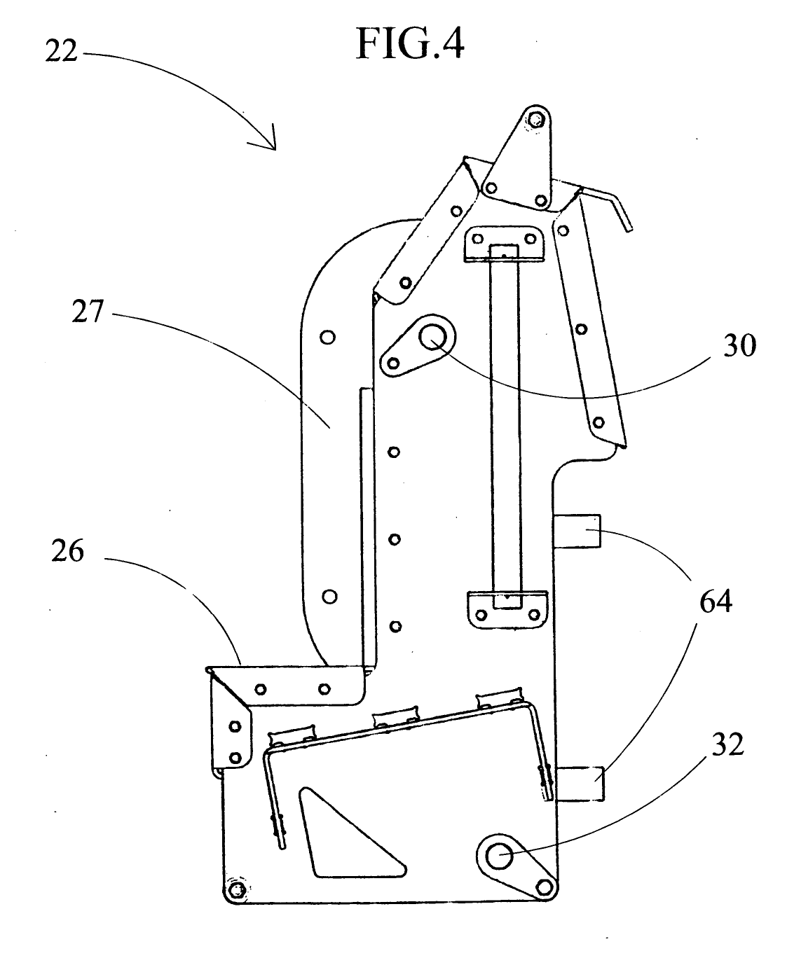

FIG. 4 shows a side view of the main external parts of the wood splitter 22: the blade 27 of the knife, the lower platform 26, the pivot axis pin 30, the support pin 32 for the cylinder and the two hydraulic connectors 64 for connecting pipes coming from an external hydraulic unit.

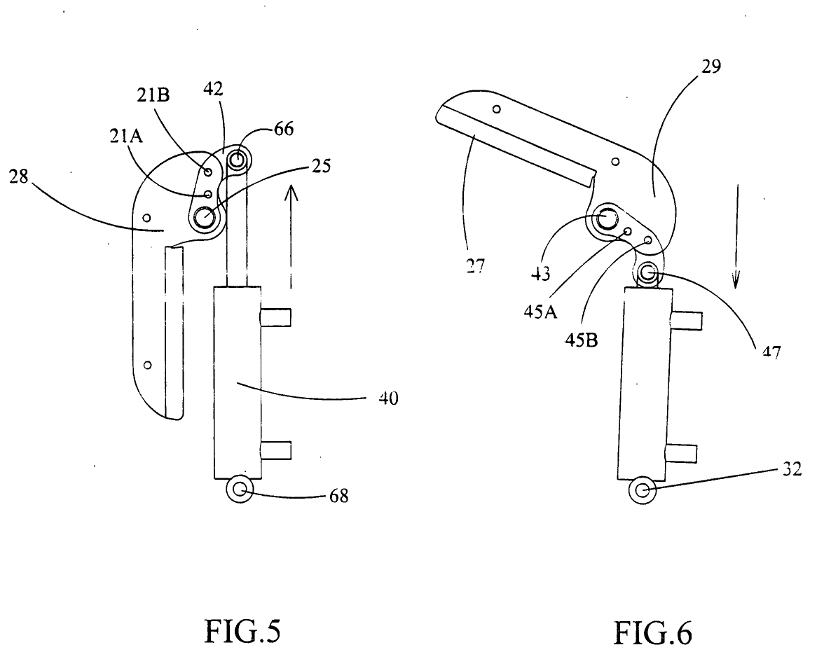

FIGS. 5 and 6 show the internal assembly and operation of the portable wood splitter with the main elements such as the knife 28, the lever 42 and the cylinder 40. FIG. 5 shows the first configuration of the elements where the knife 28 is in closed position after a cut has been performed or where the knife is in storage position.

FIG. 6 shows the second configuration of the elements where the knife 28 is in open position before a cut is performed. Between the two configurations, a movement of rotation of the knife is performed during the cutting process of a piece of wood. The rotating movement is produced by the action of the cylinder 40 which produces a mechanical force to the lever 42 which transfers the force to the arched extension 29 of the knife 28. In FIGS. 5 and 6, the cylinder head 66 is attached to the lever 42 using a cylinder attachment hole 47 connected to the lever. A cylinder foot 68 is attached to the system by the support pin 32. The knife 28 is attached to the lever 42 using the set of holes 21A, 21B, 45A and 45B. The rotation of the knife 28 is done around the axes passing through the knife hole 25 and the lever hole 43.

### SUMMARY OF THE INVENTION

The invention consists of a compact and portable wood splatter which can be easily carried and handled. It possesses handles 34,35,37 for easy transportation and a dorsal hook 39 that allows the invention to be installed on a wall or a mobile support such as a truck or car trailer. The wood splitter functions with the use of a hydraulic cylinder 40, which actuates the knife so that it carries out a pendulum movement against a piece of wood during the cut process. The piece of wood is placed on a platform 26 at the base of an enclosure provided with a rigid front part 24 which sustains a pivot point and the force of the cylinder is transmitted through the lever about the pivot point to the knife which follows a curved trajectory against the piece.

The action of the cylinder is carried out from a control valve linked to a hydraulic unit which controls the pressure of the cylinder.

### APPLICATIONS

A compact and portable wood splitter, comprises a front platform with a rectangular hole at the base of said wood splitter for allowing the support of a wood log to be cut, a knife located in the head of the wood splitter and used for wood log splitting, a hydraulic cylinder which actuates the knife, a lever linking the knife to the cylinder so that the force applied by the cylinder be transmitted to the knife.

The wood splitter comprises an “L” shaped enclosure which is composed of a material such as sheet iron, aluminium, magnesium, iron, glass, plastic or steel.

The knife comprises an external part and an internal part with regard to the enclosure. The external part of the knife comprises a blade which penetrates the wood piece and the internal part of the knife comprises a curved extension.

The curved extension comprises attachment means for the lever and comprises rotation means of the knife.

The rotation means comprises attachment means of the lever to the cylinder.

The cylinder comprises a cylinder head located at the upper extremity of the cylinder and a cylinder foot located at the lower extremity of the cylinder; the hydraulic cylinder being oriented vertically, almost perpendicular to the platform;

The rotation means of the knife comprises a pivot point and in which a pivot pin is inserted, which is also inserted inside the rotation hole of the lever, the whole assembly allowing the knife to rotate around a rotation axis located at the pivot point.

The attachment means of the knife on the lever comprise at least one attachment point comprising one hole on the knife and one hole on the lever in which a bolt is inserted for attaching the knife to the lever.

The attachment means of the lever on the cylinder comprise a pin inserted in the cylinder head and inserted in the attachment hole of the lever.

A centrally pivoted lever 42 linking the knife 28 to the cylinder 40 so that a push applied upwardly onto an end of the lever by the cylinder, be transmitted downwardly an opposite end of the lever and onto the knife, thereby splitting the wood log positioned between the knife and the base.

The attachment means of the knife on the lever comprise at least one attachment point comprising one knife hole 25 and one lever hole 43 wherein a bolt is inserted for attaching the knife to the lever.

A pin is inserted in the head 66 of the cylinder 40 and inserted in a hole located on the lever 47.

The blade 27 of the knife follows a circular trajectory realized according to a revolution angle limited by an extension of the cylinder: when the cylinder is contracted, being on its low level, the blade of the knife is on standby for cutting, when the cylinder is released, the blade of the knife is essentially parallel with the rigid front part 24 of the enclosure.

The enclosure comprises a vertical slit 50 on its front face and comprises a safety plate 58, the blade slipping inside the slit and being brought against the safety plate 58 when the cylinder is released.

The hydraulic cylinder 40 is activated from a pedal which slackens a fluid for moving a stem of the cylinder.

A method of construction of a wood splitter apparatus comprising a base part and a head part, the method having the following steps:

(a) provide an L-shaped enclosure for covering the internal elements of the apparatus and comprising a platform 26 located at the base for holding a piece of wood to be cut and a rigid front part 24;

(b) provide a knife to locate in the head and intended to slice the piece of wood; the knife consisting of two parts: a blade 27, and a curved extension 29 of the blade;

(c) provide cylinder means comprising a head 66 and a foot 68 to locate inside the enclosure and to be oriented perpendicularly of the platform;

(d) provide a lever 42 comprising attachment means for the knife and for the cylinder in order to transmit the power provided by the cylinder to the knife and provide pivot means in the lever and in the rigid front part for moving the cylinder in one direction while the knife moves in one opposite direction by seesawing the lever about the pivot.

It is to be clearly understood that the instant description with reference to the annexed drawing is made in an indicative manner and that the preferred embodiments described herein are meant in no way to limit further embodiments realizable within the scope of the invention. The matter which is claimed as being inventive and new is limited only by the following claims.

### LIST OF REFERENCE NUMERALS

20—Enclosure

21—Attachment holes

22—Portable wood splitter

23—Bearing bushing for the knife

24—Rigid front part

25—Knife pivot hole

26—Platform p 27—Blade

28—Knife

29—Internal part of the knife

30—Pivot pin

31—Lateral shelf

32—Support pin

34—Lateral handle

35—Top handle

36—Rectangular hole

37—Bottom handle

39—Dorsal hook

40—Cylinder

42—Lever

43—Lever pivot hole

44—Bearing bushing of the lever

45—Attachment holes

47—Attachment hole of the cylinder

50—Slit

58—Safety plate

64—Hydraulic connectors

66—Cylinder head

68—Cylinder foot

I claim:

1. A compact and portable wood splitter apparatus comprising a base and a head, said apparatus further comprising:
(a) a front platform (26) located at said base and comprising means for allowing the support of a wood log to be cut;
(b) a knife (28) located at said head and adapted for splitting said wood log;
(c) a hydraulic cylinder (40) positioned between said base and said head for lowering said knife (28) onto said tog;
(d) a centrally pivoted lever (42) linking said knife (28) to said cylinder (40) so that a push applied upwardly onto an end of said lever by said cylinder, be transmitted downwardly an opposite end of said lever and onto said knife, thereby splitting said wood log positioned between said knife and said base.

2. The apparatus of claim 1 comprising an “L” shaped enclosure which is composed of a material from a group comprising sheet iron, aluminium, magnesium, iron, glass, plastic or steel.

3. The apparatus of claim 2 wherein said enclosure comprises a rigid front part sustaining a pivot point (23) of said lever, said knife (28) comprises an external part (27) forward of said forward structure and an internal part (29) within said enclosure, said external part comprising a blade adapted to penetrate said wood log and said internal part comprising a curved extension.

4. The apparatus of claim 3 wherein said curved extension comprises attachment means for said lever and comprises rotation means for said knife.

5. The apparatus of claim 4 wherein said rotation means comprise attachment means between said lever and said cylinder.

6. The apparatus of claim 5 wherein said rotation means of said knife comprise a pivot pin (30) inserted inside a rotation hole (43) of said lever, the whole assembly allowing said knife to rotate around a rotation axis located at a pivot point (25).

7. The apparatus of claim 6 wherein said attachment means of said knife on said lever comprise at least one attachment point comprising one knife hole (25) and one lever hole (43) wherein a bolt is inserted for attaching said knife to said lever.

8. The apparatus of claim 5 wherein said attachment means of said lever on said cylinder comprise a pin inserted in the head (66) of said cylinder (40) and inserted in a hole located on said lever (47).

9. The apparatus of claim 1 wherein said cylinder comprises a cylinder head (66) located at an upper extremity thereof and a cylinder foot (68) located at a lower extremity thereof; said cylinder being oriented vertically, almost perpendicular to said platform.

10. The apparatus of claim 1 wherein said cylinder (40) is supported by supporting means comprising an enclosure (20) comprising handles (34) located on both sides of said enclosure and comprising an opening located on cylinder foot (68) of said cylinder and by which a support pin (32) is inserted.

11. The apparatus of claim 1 wherein the blade (27) of said knife follows a circular trajectory realized according to a revolution angle limited by an extension of said cylinder: when said cylinder is contracted, being on its low level, said blade of said knife is on standby for cutting, when said cylinder is released, said blade of said knife is essentially parallel with said rigid front part (24) of said enclosure.

12. The apparatus of claim 2 wherein said enclosure comprises a vertical slit (50) on its front face and comprises a safety plate (58), said blade slipping inside said slit and being brought against said safety plate (58) when said cylinder is released.

13. The apparatus of claim 1 wherein said hydraulic cylinder (40) is activated from a pedal which slackens a fluid for moving a stem of the cylinder.

14. The apparatus of claim 2 wherein said enclosure comprises carrying means comprising lateral handle (34), top handle (35), and bottom handle (37) allowing the user to raise and transport said apparatus from a place to another.

15. The apparatus of claim 2 wherein said enclosure comprises a removable lateral shelf (31).

16. A method of construction of a wood splitter apparatus comprising a base part and a head part, said method having the following steps:
(a) provide an L-shaped enclosure for covering the internal elements of said apparatus and comprising a platform (26) located at said base for holding a piece of wood to be cut and a rigid front part (24);
(b) provide a knife to locate in said head and intended to slice said piece of wood; said knife consisting of two parts: a blade (27), and a curved extension (29) of said blade;
(c) provide cylinder means comprising a head (66) and a foot (68) to locate inside said enclosure and to be oriented perpendicularly of said platform;
(d) provide a lever (42) comprising attachment means for said knife and for said cylinder in order to transmit the power provided by said cylinder to said said knife and provide pivot means in said lever and in said rigid front part for moving said cylinder in one direction while said knife moves in one opposite direction by seesawing said lever about said pivot.

17. A wood splitter for wood defining a lengthened body standing in an upright position, a flat base and a head, said lengthened body consisting in longitudinal fibres, said wood splitter comprising:
(a) a platform (26) for said base of said lengthened body, said platform comprising an extension;
(b) a push cylinder laid out on said extension;
(c) a knife laid out above said lengthened body;
(d) a pivot pin (30) laid out at the level of said head:
(e) a lever laid out between said head and said cylinder and rotating abound said pivot pin;
(f) a push of said cylinder causing said lever to push said knife against said lengthened body.

18. The apparatus of claim 1 wherein said platform comprises a rectangular hole (36) for evacuating remains of a cutting operation.
